(19) United States
(12) Patent Application Publication
(10) Pub. No.: US 2012/0320302 A1
(43) Pub. Date: Dec. 20, 2012

(54) LCD BACK PLATE AND A MANUFACTURING METHOD THEREOF

(75) Inventors: Yu-chun Hsiao, Shenzhen (CN); Gang Yu, Shenzhen (CN)

(73) Assignee: Shenzhen China Star Optoelectronics Technology Co., Ltd., Shenzhen (CN)

(21) Appl. No.: 13/258,770

(22) PCT Filed: Jun. 23, 2011
(86) PCT No.: PCT/US2011/076209

§ 371 Date: Sep. 22, 2011

(30) Foreign Application Priority Data
Jun. 16, 2011 (CN) 201110162566.0

(51) Int. Cl. G02F 1/1333; B23P 11/00

(52) U.S. Cl. 349/58; 29/428

(57) ABSTRACT

The present invention discloses an LCD back plate which has two regions with different thermal conductivity coefficients. The LCD back plate comprises a first region and a second region, the first region is close to a light input side of the LCD back plate. The first region has a first metal plate, while the second region has a second metal plate. The thermal conductivity coefficient of the first metal plate is greater than that of the second metal plate. The light input side of the LCD back plate of the present invention uses a metal plate with a higher thermal conductivity coefficient to satisfy a higher heat-dissipation demand at the light input side of the LCD back plate, while the remaining region of the LCD back plate uses another metal plate having a lower cost. The design of the present invention not only can provide a better heat-dissipation effect, but also can lower the cost of products. The manufacturing method of the LCD back plate of the present invention is connected by welding or riveting, so that the manufacture efficiency can be enhanced. Furthermore, it is unnecessary to have a staggered arrangement design for fastening the screws, so as to lower the design difficulty.

### FIELD OF THE INVENTION

The present invention relates to a liquid crystal display (LCD) back plate, and the present invention further relates to a manufacturing method of the LCD back plate.

### BACKGROUND OF THE INVENTION

Recently, liquid crystal display (LCD) modules are more widely applied to daily life of humans, such as LCDs of LCD televisions, notebook computers and desktop computers. Because internal components in the LCD module are sensitive to the temperature and internal structures therein are complicated, there is a high heat-dissipation demand. Meanwhile, if the heat-dissipation is not smooth, the stability of product performance and the life time of products will be substantially affected.

Referring to FIG. 1, in a traditional LCD module, a back plate (i.e. back bezel) is simply made of aluminum material or an electro-galvanized steel sheet, wherein the price of the former is high, and the heat-dissipation effect of the later is just general. In actual measurements, it is found that the back plate is not entirely used to dissipate heat, and only a portion within a length starting from a light source has the heat-dissipation effect. Thus, if the entire back plate is made of aluminum material, it will cause the waste of some material, resulting in increasing the manufacture cost of products. In addition, the traditional design uses screws to fasten segmented back plate. However, on one hand, the efficiency of this method is low; and on the other hand, the design must have a staggered arrangement design for fastening the screws, so as to increase the design difficulty.

### SUMMARY OF THE INVENTION

A primary object of the present invention is to provide a manufacturing method of an LCD back plate for solving the problem of the back plate, so as to lower the cost thereof and improve the heat-dissipation at the same time.

The technical solution provided by the present invention is described, as follows:

A liquid crystal display (LCD) back plate, which is characterized in that: the LCD back plate comprises a first region and a second region, the first region is close to a light input side (edge) of the LCD back plate, and the first region has a first metal plate, the second region has a second metal plate, wherein the thermal conductivity coefficient of the first metal plate is greater than that of the second metal plate; a central portion of the first metal plate is protruded, and a central portion of the second metal plate is recessed, the protruded central portion of the first metal plate is matched with the recessed central portion of the second metal plate, and the first metal plate is connected with the second metal plate by welding.

A liquid crystal display (LCD) back plate is provided, wherein the LCD back plate has two regions with different thermal conductivity coefficients.

In one embodiment of the present invention, the LCD back plate comprises a first region and a second region, the first region is close to a light input side of the LCD back plate, the first region has a first metal plate, and the second region has a second metal plate, wherein the thermal conductivity coefficient of the first metal plate is greater than that of the second metal plate.

In one embodiment of the present invention, the first metal plate is connected with the second metal plate by welding.

In one embodiment of the present invention, the first metal plate is connected with the second metal plate by riveting.

In one embodiment of the present invention, the first region of the LCD back plate is punched to form a recessed portion, and the recessed portion is provided with (LED) light bars.

In one embodiment of the present invention, the first region of the LCD back plate is punched to form a recessed portion, and the recessed portion is provided with supports which are installed with (LED) light bars.

In one embodiment of the present invention, the first metal plate is overlapped with the second metal plate, and a portion of the first metal plate overlapped with the second metal plate is bent upward and parallel to the second metal plate, wherein a bent height of the bent portion is equal to the thickness of the second metal plate.

In one embodiment of the present invention, a central portion of the first metal plate is protruded, and a central portion of the second metal plate is recessed, the protruded central portion of the first metal plate is matched with the recessed central portion of the second metal plate.

In one embodiment of the present invention, material of the first metal plate is aluminum or copper, and material of the second metal plate is electro-galvanized steel.

The present invention further comprises a manufacturing method of a liquid crystal display (LCD) back plate, and the technical solution thereof is described, as follows:

A manufacturing method of an LCD back plate is provided, and comprises the following steps of:

providing two first metal plates close to two light input sides (edges) of the LCD back plate;

providing a second metal plate in the remaining region of the LCD back plate; and

connecting the first metal plates with the second metal plate.

In one embodiment of the present invention, the first metal plate is connected with the second metal plate by welding.

In one embodiment of the present invention, the first metal plate is connected with the second metal plate by riveting.

In one embodiment of the present invention, further comprising the following steps of:

punching the first metal plate of the LCD back plate to form a recessed portion; and then directly fastening (LED) light bars in the recessed portion.

In one embodiment of the present invention, further comprising the following steps of:

punching the first metal plate of the LCD back plate to form a recessed portion; providing supports in the recessed portion; and then fastening (LED) light bars on the supports.

The LCD back plate of the present invention is designed according to a heat-dissipation simulation diagram, because the first region defining two ends of the LCD back plate is relatively close to a heat-generating (light) source and thus has a higher heat-dissipation demand, a metal plate with a higher thermal conductivity coefficient is used, and the second region defining a central portion of the back plate uses another metal plate having a lower cost. Thus, the LCD back plate of the present invention not only can provide a better heat-dissipation effect, but also can lower the cost of products. The manufacturing method of the LCD back plate of the present invention only needs a set of molds to finish the LCD back plate, so that the cost of the molds can be saved. Because the manufacturing method of the LCD back plate of the present invention is connected by welding or riveting, the manufacture efficiency can be enhanced. The manufacturing method of the LCD back plate of the present invention doesn't need to use screws for fastening segmented back plate, it is unnecessary to have a staggered arrangement design for fastening the screws, so as to lower the design difficulty.

### DESCRIPTION OF THE DRAWINGS

FIG. 1 is a schematic view of a traditional LCD back plate;

FIG. 2 is a schematic view of an LCD back plate according to a first preferred embodiment of the present invention;

FIG. 3 is a single sided light input type heat-dissipation simulation diagram of the LCD back plate according to the present invention;

FIG. 4 is cross-sectional views of an LCD back plate according to a second preferred embodiment of the present invention;

FIG. 5 is cross-sectional views of an LCD back plate according to a third preferred embodiment of the present invention;

FIG. 6 is cross-sectional views of an LCD back plate according to a fourth preferred embodiment of the present invention; and

FIG. 7 cross-sectional views of an LCD back plate according to a fifth preferred embodiment of the present invention.

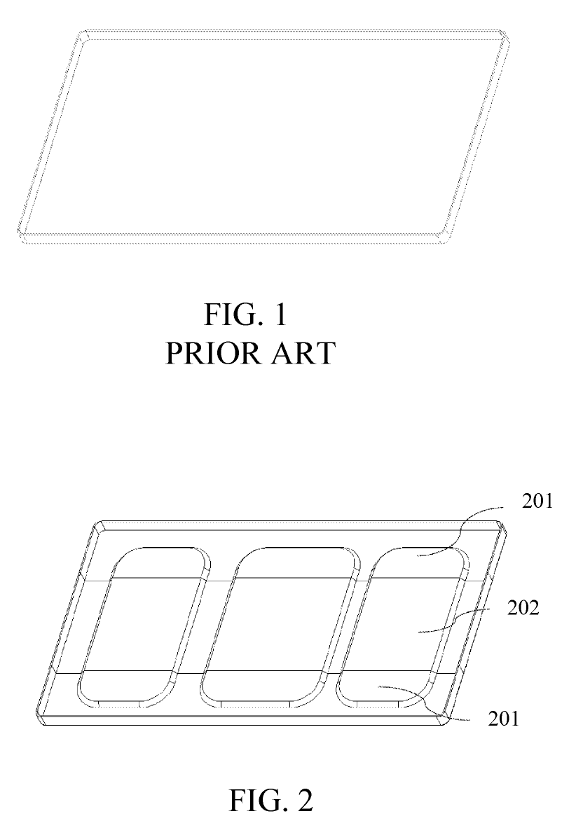

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings.

### Embodiment 1

Referring now to FIG. 2, a schematic view of a liquid crystal display (LCD) back plate according to a first preferred embodiment of the present invention is illustrated and has two regions with different thermal conductivity coefficients. The embodiment is suitably applied to double sided light input type LCD emitted from upper and lower sides thereof. In the embodiment, the LCD back plate comprises a first region and a second region. The first region is disposed on and defines two ends of the LCD back plate, and the first region has a first metal plate 201. The second region is disposed on and defines a central portion of the LCD back plate, and the second region has a second metal plate 202. The first metal plate 201 defining two ends of the LCD back plate has a thermal conductivity coefficient greater than that of the second metal plate 202 defining the central portion of the LCD back plate. The foregoing design can satisfy the higher heat-dissipation demand on two ends of the LCD back plate. The first metal plate 201 uses material with a higher thermal conductivity coefficient, such as aluminum, copper and etc., for providing a better heat-dissipation effect. The second metal plate 202 uses metal plate with a lower cost, such as electro-galvanized steel sheet (SECC).

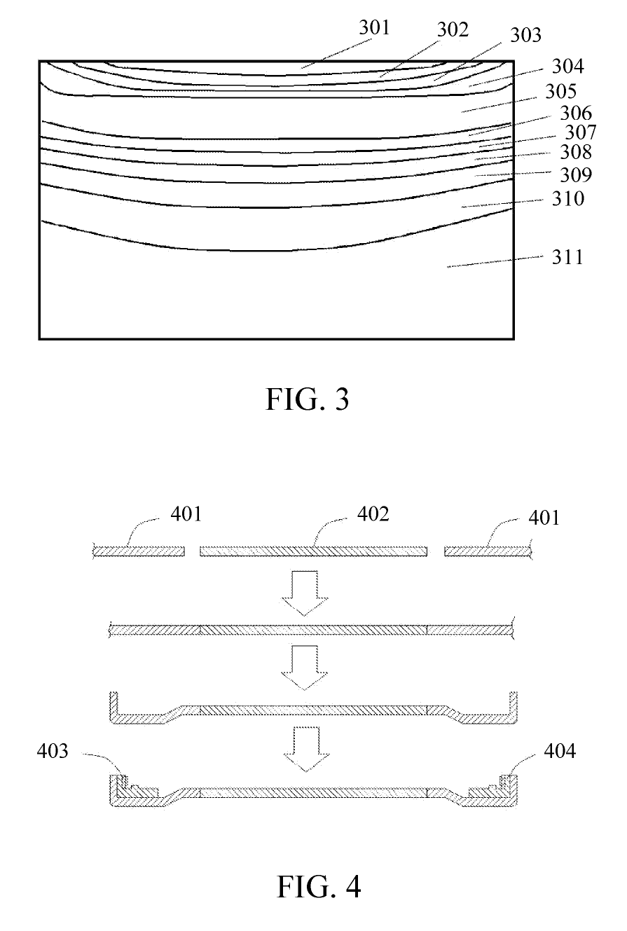

FIG. 3 is a single sided light input type heat-dissipation simulation diagram of the LCD back plate. As shown in FIG. 3, a region 301 is dark red; a region 302 is red; a region 303 is orange; a region 304 is yellow; a region 305 is green; a region 306 is light cyan; a region 307 is cyan; a region 308 is blue; a region 309 is light blue; a region 310 is blue; and a region 311 is dark blue. The temperature of the LCD back plate is gradually lowered from the region 301 to the region 311. In the embodiment, the LCD back plate is double sided light input type LCD in which light is emitted from upper and lower sides thereof. An upper portion of the LCD back plate has a temperature distribution as shown in the single sided light input type heat-dissipation simulation diagram of FIG. 3, and the temperature of the light input side is gradually lowered from an upper edge toward a central portion of the back plate. A lower portion of the LCD back plate has a temperature distribution as shown in the single sided light input type heat-dissipation simulation diagram of FIG. 3, and the temperature of the light input side is gradually lowered from a lower edge toward a central portion of the back plate. The first metal plate 201 on the two ends of the LCD back plate has an area designed according to the heat-dissipation simulation diagram of the LCD back plate in FIG. 3 and the heat-dissipation demands, in order to provide a better heat-dissipation effect. For example, the first metal plate 201 can be provided on both of the upper and lower ends, and the first metal plate 201 on each of the two ends can cover the regions 301-304, respectively.

In the embodiment, the LCD back plate is provided with three rectangular protrusions to strengthen the strength of the back plate. The first metal plate 201 is connected with the second metal plate 202 by welding. The design of the embodiment uses the welding means to carry out the connection, so as to enhance the manufacture efficiency. The design of the present invention doesn't need to use screws for fastening segmented back plate, it is unnecessary to have a staggered arrangement design for fastening the screws, so as to lower the design difficulty. The LCD back plate designed by the present invention has a temperature which is only slightly different from that of the traditional LCD back plate (entirely made of aluminum material), wherein the difference therebetween is only one degree. The design of the present invention not only can maintain a better heat-dissipation effect, but also can lower the cost of products.

### Embodiment 2

Referring now to FIG. 4, the embodiment is further described more detailed than the embodiment 1, wherein a first metal plate 401 on two ends of an LCD back plate is firstly connected with a second metal plate 402 on a central portion of the LCD back plate by welding. Then, the first metal plate 401 on the two ends of the LCD back plate is punched to form a recessed portion according to a predetermined mold shape, followed by directly fastening light bars in the recessed portion. The ratio of length and area between the first metal plate 401 and second metal plate 402 can be set according to heat-dissipation simulation results. In the embodiment, the recessed portion of the first metal plate 401 on the two ends of the LCD back plate can be provided with supports 404 for fastening the light bars 403. In other case, the light bars 403 also can be directly fastened in the recessed portion on the two ends of the LCD back plate.

### Embodiment 3

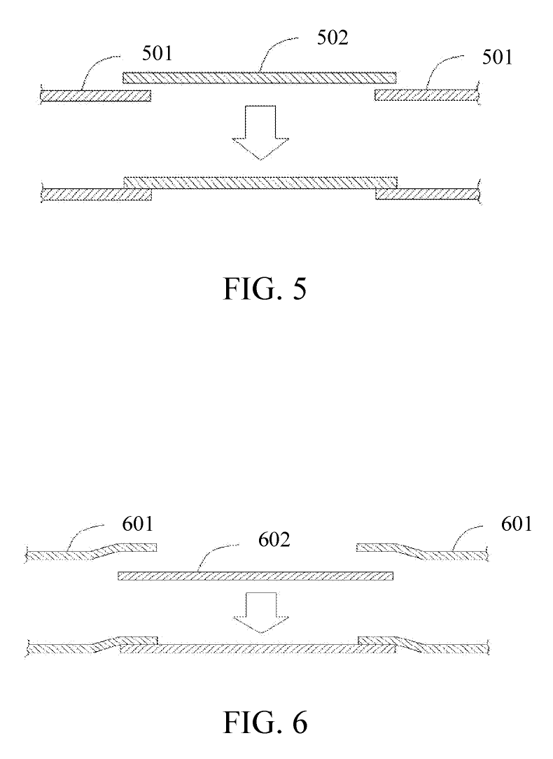

Referring now to FIG. 5, the difference between the embodiment and the embodiment 1 is that: a first metal plate 501 on two ends of an LCD back plate is firstly connected with a second metal plate 502 on a central portion of the LCD back plate by riveting. In more details, firstly providing two first metal plates 501 disposing on two ends of the LCD back plate; and providing a second metal plate 502 disposing on a central portion of the LCD back plate, wherein the first metal plates 501 are overlapped with the second metal plate 502. Then, connecting the first metal plate 501 with the second metal plate 502 by riveting. The design of the embodiment uses the riveting means to carry out the connection, so as to enhance the manufacture efficiency. The design of the present invention doesn't need to use screws for fastening segmented back plate, it is unnecessary to have a staggered arrangement design for fastening the screws, so as to lower the design difficulty.

### Embodiment 4

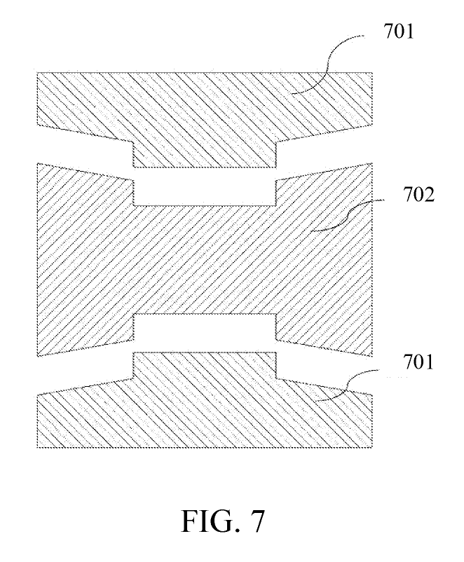

Referring now to FIG. 6, the difference between the embodiment and the embodiment 3 is that: a first metal plate 601 is overlapped with a second metal plate 602, and a portion of the first metal plate 601 overlapped with the second metal plate 602 is bent upward and parallel to the second metal plate 602, wherein a bent height of the bent portion can be preferably equal to the thickness of the second metal plate 602. The design of the present invention can improve the flatness of the LCD back plate after riveting and ensure the flatness of LCD installation. Then, the first metal plate 601 is connected with the second metal plate 602 by riveting.

### Embodiment 5

Referring now to FIG. 7, the difference between the embodiment and the embodiment 1 is that: a central portion of a first metal plate 701 is protruded, and a central portion of a second metal plate 702 is recessed, the protruded central portion of the first metal plate 701 is matched with the recessed central portion of the second metal plate 702, and the first metal plate 701 is connected with the second metal plate 702 by welding (brazing). The LCD back plate designed by the present invention can increase the area of the first metal plate 701 which is dispose on the central region with a higher temperature and has a higher thermal conductivity coefficient, i.e. increase the material of the central region, and decrease the material of the two sides thereof, in order to improve the heat-dissipation effect. The design of the embodiment can ensure the temperature evenness of the LCD module, so as to prevent the partially overheating problem and the display malfunction problem.

In more details, the first metal plate can be disposed according to the light input distribution of the LCD back plate. For a back plate of a single sided light input type LCD, the first metal plate is provided on and close to a light input side (edge). For a back plate of a three sided light input type LCD, the first metal plates are provided on and close to three light input sides (edges). For a back plate of a four sided light input type LCD, the first metal plates are provided on and close to four light input sides (edges). The ratio of area between the first metal plate and second metal plate can be set according to heat-dissipation simulation results and heat-dissipation demands.

The present invention has been described with a preferred embodiment thereof and it is understood that many changes and modifications to the described embodiment can be carried out without departing from the scope and the spirit of the invention that is intended to be limited only by the appended claims.

1. A liquid crystal display (LCD) back plate, characterized in that: the LCD back plate comprises a first region and a second region, the first region is close to a light input side of the LCD back plate, and the first region has a first metal plate, the second region has a second metal plate, wherein the thermal conductivity coefficient of the first metal plate is greater than that of the second metal plate; a central portion of the first metal plate is protruded, and a central portion of the second metal plate is recessed, the protruded central portion of the first metal plate is matched with the recessed central portion of the second metal plate, and the first metal plate is connected with the second metal plate by welding.

2. A liquid crystal display (LCD) back plate, characterized in that: the LCD back plate has two regions with different thermal conductivity coefficients.

3. The LCD back plate according to claim 2, wherein the LCD back plate comprises a first region and a second region, the first region is close to a light input side of the LCD back plate, the first region has a first metal plate, and the second region has a second metal plate, wherein the thermal conductivity coefficient of the first metal plate is greater than that of the second metal plate.

4. The LCD back plate according to claim 3, wherein the first metal plate is connected with the second metal plate by welding.

5. The LCD back plate according to claim 3, wherein the first metal plate is connected with the second metal plate by riveting.

6. The LCD back plate according to claim 3, wherein the first region of the LCD back plate is punched to form a recessed portion, and the recessed portion is provided with light bars.

7. The LCD back plate according to claim 3, wherein the first region of the LCD back plate is punched to form a recessed portion, and the recessed portion is provided with supports which are installed with light bars.

8. The LCD back plate according to claim 5, wherein the first metal plate is overlapped with the second metal plate, and a portion of the first metal plate overlapped with the second metal plate is bent upward and parallel to the second metal plate, wherein a bent height of the bent portion is equal to the thickness of the second metal plate.

9. The LCD back plate according to claim 3, wherein a central portion of the first metal plate is protruded, and a central portion of the second metal plate is recessed, the protruded central portion of the first metal plate is matched with the recessed central portion of the second metal plate.

10. The LCD back plate according to claim 3, wherein material of the first metal plate is aluminum or copper, and material of the second metal plate is electro-galvanized steel.

11. A manufacturing method of a liquid crystal display (LCD) back plate, characterized in that: comprising steps of:
providing two first metal plates close to two light input sides of the LCD back plate;
providing a second metal plate in the remaining region of the LCD back plate; and
connecting the first metal plates with the second metal plate.

12. The manufacturing method of the LCD back plate according to claim 11, characterized in that: the first metal plate is connected with the second metal plate by welding.

13. The LCD back plate and a manufacturing method thereof according to claim 11, characterized in that: the first metal plate is connected with the second metal plate by riveting.

14. The LCD back plate and a manufacturing method thereof according to claim 11, characterized in that: further comprising steps of:
punching the first metal plate of the LCD back plate to form a recessed portion; and then directly fastening light bars in the recessed portion.

15. The LCD back plate and a manufacturing method thereof according to claim 11, characterized in that: further comprising steps of:
punching the first metal plate of the LCD back plate to form a recessed portion; providing supports in the recessed portion; and then fastening light bars on the supports.
